(19) United States
(12) Patent Application Publication
(10) Pub. No.: US 2026/0342447 A1
(43) Pub. Date: Oct. 29, 2026

(54) OPTICAL WIRELESS COMMUNICATION SYSTEM AND OPTICAL WIRELESS COMMUNICATION DEVICE

(71) Applicant: Mitsubishi Electric Corporation, Tokyo (JP)

(72) Inventor: Mizuki SHIRAO, Tokyo (JP)

(73) Assignee: Mitsubishi Electric Corporation, Tokyo (JP)

(21) Appl. No.: 19/713,585

(22) Filed: Jun. 18, 2026

Related U.S. Application Data
(63) Continuation of application No. PCT/JP2024/004439, filed on Feb. 9, 2024.

(51) Int. Cl. H04B 10/61; H04B 10/079

(52) U.S. Cl. CPC H04B 10/61; H04B 10/07957

(57) ABSTRACT

An optical wireless communication system includes a pair of optical wireless communication devices, each of which includes: a plurality of optical transmitters to transmit optical signals of target wavelengths; an optical multiplexing/demultiplexing unit to multiplex the optical signals and transmit the multiplexed optical signal to a counterpart optical wireless communication device, and to demultiplex an optical signal from the counterpart optical wireless communication device into optical signals of a plurality of wavelengths; and a plurality of optical receivers to receive the optical signals of target wavelengths, the target wavelengths of the optical transmitters and the optical receivers are wavelengths that are allocated alternately in order of length, and between the pair of optical wireless communication devices, the target wavelengths of the optical transmitters and the optical receivers are shifted from each other by one wavelength.

### DESCRIPTION

### CROSS REFERENCE TO RELATED APPLICATION

This application is a Continuation of PCT International Application No. PCT/JP2024/004439, filed on Feb. 9, 2024, which is hereby expressly incorporated by reference into the present application.

### TECHNICAL FIELD

The present disclosure relates to an optical wireless communication system including optical wireless communication devices to transmit and receive optical signals and relates to the optical wireless communication devices.

### BACKGROUND ART

Free-space optical communication via free space is expected to become widespread, with inter-satellite optical communication as a principal example thereof.

For example, with reference to ITU-T G.694.1 as an inter-satellite communication standard, Non-Patent Literature 1 discloses that two wavelengths of 193.1+n×0.1 THz (n = -1, +20) are allocated to transmission and reception.

In addition, these wavelengths are required to be switchable by software, that is, the transmission wavelength and the reception wavelength are required to be interchangeable. This is because, in free-space optical communication, in particular in inter-satellite optical communication, it is necessary to interchange the transmission wavelength and the reception wavelength in order to avoid crosstalk between communicating apparatuses.

For example, Tx and Rx are allocated to CH_A and CH_B, respectively, in one of two apparatuses, and Rx and Tx are allocated to CH_A and CH_B, respectively, in the other apparatus. In each apparatus, the wavelengths allocated to Tx and Rx are interchangeable.

Note that the reason why the two wavelengths are significantly wider than 100 GHz in the ITU-T grid is to facilitate wavelength separation.

### CITATION LIST

### NON-PATENT LITERATURES

Non-Patent Literature 1: Optical Communications Terminal (OCT) Standard Version 3.0

### SUMMARY OF INVENTION

### TECHNICAL PROBLEM

In free-space optical communication, there are two possible methods for enhancing the communication bandwidth: a method of increasing the information amount per wavelength, that is, a method of increasing the modulation rate; and a method of increasing the number of wavelengths (WDM: Wavelength Division Multiplexing).

The method of increasing the modulation rate involves a trade-off with reception sensitivity. That is, in inter-satellite optical communication that requires a link length of several thousand kilometers, beam divergence in free space is unavoidable, and the power reaching a photoreceiver is extremely low.

Accordingly, this method of increasing the modulation rate is not preferable since high reception sensitivity is essential for the system

In this regard, the method of increasing the number of wavelengths is a technology for enhancing the communication bandwidth without changing the modulation rate and is also widely used in optical fiber communication.

On the other hand, in the communication disclosed in Non-Patent Literature 1, as described above, the transmission wavelength and the reception wavelength need to be programmatically switched.

The most reliable method for enabling the wavelength switching is to prepare devices corresponding to individual wavelengths.

However, in the case of this method, an increase in device size and an increase in cost are problems.

In this regard, other methods for enabling wavelength switching also include a method of preparing a wavelength-tunable light source and switching the wavelength on the basis of requests.

In the case of this method, the wavelength filter for separating the transmission wavelength and the reception wavelength needs to be tunable. However, it is difficult with typically-used multilayer film filters to interchange the wavelengths.

In addition, in the wavelength grid (193.1+n×0.1 THz (n = -1, +20)) disclosed in Non-Patent Literature 1, there are only two wavelengths for transmission and reception.

However, in a case where multi-wavelength operations are performed in order to achieve higher capacity in the future, the system undesirably becomes very complex no matter which of the wavelength switching methods described above is used.

The present disclosure has been made to solve the problems described above, and an object thereof is to provide an optical wireless communication system that can use a large number of wavelengths and facilitate wavelength switching compared with conventional techniques.

### SOLUTION TO PROBLEM

An optical wireless communication system according to the present disclosure is an optical wireless communication system including a pair of optical wireless communication devices, in which each of the optical wireless communication devices includes: a plurality of optical transmitters to transmit optical signals of target wavelengths; an optical multiplexer/demultiplexer to multiplex the optical signals transmitted by the optical transmitters and transmit the multiplexed optical signal to a counterpart optical wireless communication device, which is the other one of the pair of optical wireless communication devices, and to demultiplex an optical signal from the counterpart optical wireless communication device into optical signals of a plurality of wavelengths; a plurality of optical receivers to receive the optical signals of target wavelengths from among the optical signals demultiplexed by the optical multiplexer/demultiplexer; and a wavelength filter that is provided to each of the optical receivers, the wavelength filter transmitting optical signals of two wavelengths which are target wavelengths of the corresponding optical receiver from among the demultiplexed optical signals by the optical multiplexer/demultiplexer, wherein the target wavelengths of the optical transmitters and the optical receivers are wavelengths that are allocated alternately in order of length, between the pair of optical wireless communication devices, the target wavelengths of the optical transmitters and the optical receivers are shifted from each other by one wavelength, the optical multiplexer/demultiplexers are AWGs, the number of ports is one greater than a total number of the target wavelengths of the optical transmitters and the optical receivers, and the corresponding optical receiver receives the optical signals transmitted through the wavelength filter.

### ADVANTAGEOUS EFFECTS OF INVENTION

Since the present disclosure adopts the configuration described above, a large number of wavelengths can be used, and wavelength switching is facilitated compared with conventional techniques.

### BRIEF DESCRIPTION OF DRAWINGS

FIG. 1 is a drawing illustrating a configuration example of an optical wireless communication system according to a first embodiment.

FIG. 2 is a drawing illustrating an allocation example of target wavelengths of the optical wireless communication system according to the first embodiment.

FIG. 3 is a drawing illustrating a configuration example of a first optical wireless communication device according to the first embodiment.

FIG. 4 is a drawing illustrating a configuration example of a second optical wireless communication device according to the first embodiment.

FIG. 5 is a drawing illustrating a setting example of target wavelengths of the first optical wireless communication device and target wavelengths of the second optical wireless communication device according to the first embodiment.

FIG. 6 is a drawing illustrating a configuration example of a first optical wireless communication device according to a second embodiment.

FIG. 7 is a drawing illustrating a configuration example of a first optical wireless communication device according to a third embodiment.

FIG. 8 is a drawing illustrating a setting example of a target band of a first wavelength filter in the third embodiment.

FIG. 9 is a drawing illustrating a configuration example of a first optical wireless communication device according to a fourth embodiment.

FIG. 10 is a drawing illustrating a configuration example of a second optical wireless communication device according to the fourth embodiment.

### DESCRIPTION OF EMBODIMENTS

Hereinbelow, embodiments are explained in detail with reference to the drawings.

### First Embodiment.

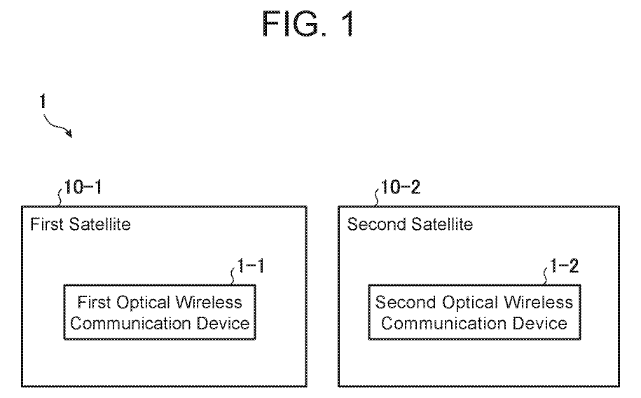

FIG. 1 is a drawing illustrating a configuration example of an optical wireless communication system according to a first embodiment.

The optical wireless communication system is a system that includes a pair of optical wireless communication devices 1 between which communication is performed.

As illustrated in FIG. 1, the optical wireless communication system includes a first optical wireless communication device 1-1 and a second optical wireless communication device 1-2.

Note that, here, in a case where it is necessary to distinguish between the optical wireless communication devices 1 and between components included in the optical wireless communication devices 1, suffixes (-1, -2) are given to the reference signs.

In addition, here, as communication performed by the optical wireless communication devices 1, communication between satellites 10 on which the optical wireless communication devices 1 are mounted is explained as an example.

However, communication performed by the optical wireless communication devices 1 is not limited to this. For example, the communication may be communication for terrestrial use or for aircraft, in which similar configurations can be applied to the optical wireless communication devices 1.

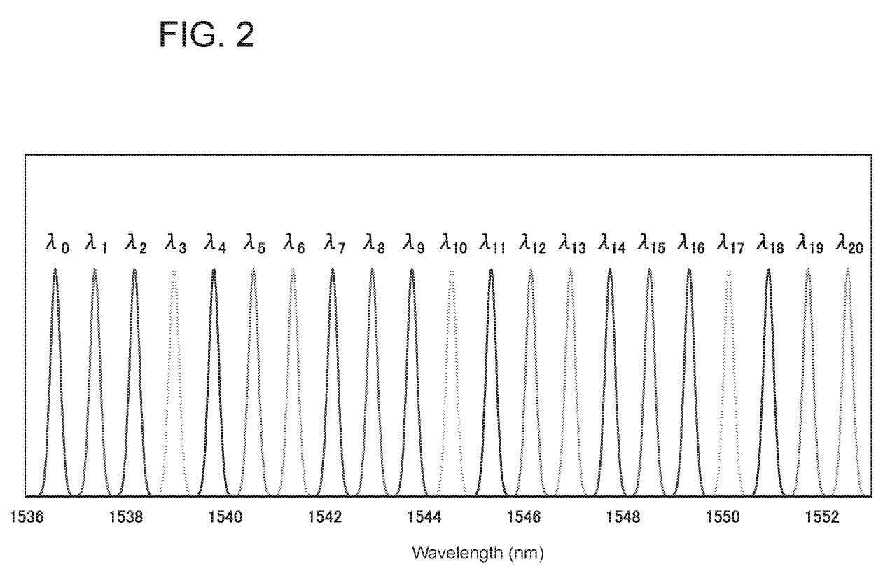

Note that FIG. 2 illustrates an allocation example of target wavelengths of the optical wireless communication system according to the first embodiment.

Here, as illustrated in FIG. 2, target wavelengths of the optical wireless communication system are set in a grid constituted by 21 wavelengths at 100-GHz intervals. In the example in FIG. 2, the wavelength grid is a wavelength grid (193.1+n×0.1 THz (n = 0, ⋅⋅⋅, 20)) defined in ITU-T G.694.1. In addition, the 100-GHz intervals are equivalent to approximately 0.8 nm.

In FIG. 2, λ₀ to λ₂₀ represent the target wavelengths of the optical wireless communication system.

For example, as illustrated in FIG. 1, the first optical wireless communication device 1-1 is mounted on a first satellite 10-1 and communicates with the counterpart second optical wireless communication device 1-2.

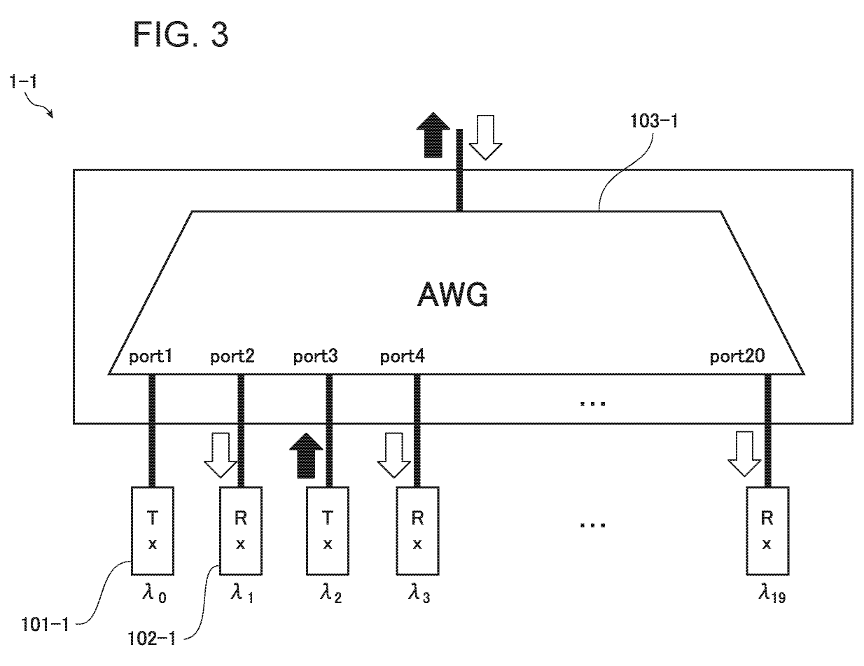

For example, as illustrated in FIG. 3, the first optical wireless communication device 1-1 includes a plurality of first optical transmitting units (Tx) 101-1, a plurality of first optical receiving units (Rx) 102-1, and a first optical multiplexing and demultiplexing unit (AWG) 103-1.

Each first optical transmitting unit 101-1 transmits an optical signal of a target wavelength to the first optical multiplexing and demultiplexing unit 103-1.

For example, semiconductor lasers are used as the first optical transmitting units 101-1. For example, Directly Modulated Lasers (DMLs) or Electro-absorption modulator integrated Laser diodes (EMLs) in which optical modulators are integrated are used as the semiconductor lasers.

For example, the oscillation wavelength of the DMLs and the oscillation wavelength of the EMLs have temperature characteristics of approximately 0.08 nm/K, and the wavelengths of optical signals to be output can be changed by changing the temperature.

Each first optical receiving unit 102-1 receives an optical signal of a target wavelength from among optical signals demultiplexed by the first optical multiplexing and demultiplexing unit 103-1.

For example, Avalanche Photo Diodes (APDs) are used as the first optical receiving units 102-1.

The APDs can receive light irrespective of temperature as long as the wavelength of the light falls within the wavelength band to which the APDs are sensitive.

In addition, the target wavelengths of the individual first optical transmitting units 101-1 and the individual first optical receiving units 102-1 are wavelengths allocated to the individual first optical transmitting units 101-1 and the individual first optical receiving units 102-1 alternately in order of length from among a plurality of the target wavelengths of the first optical wireless communication device 1-1.

In the example in FIG. 3, λ₀, λ₂, ⋅⋅⋅, and λ₁₈ are allocated to the individual first optical transmitting units 101-1, and λ₁, λ₃, ⋅⋅⋅, and λ₁₉ are allocated to the individual first optical receiving units 102-1.

The first optical multiplexing and demultiplexing unit 103-1 is an optical waveguide that has a plurality of ports and multiplexes and demultiplexes optical signals. The first optical multiplexing and demultiplexing unit 103-1 has a function of demultiplexing wavelength-multiplexed light into a plurality of ports and a function of multiplexing light of particular wavelengths input to a plurality of ports.

That is, the first optical multiplexing and demultiplexing unit 103-1 multiplexes optical signals transmitted by the first optical transmitting units 101-1 and transmits an optical signal obtained by the multiplexing to the second optical wireless communication device 1-2, and the first optical multiplexing and demultiplexing unit 103-1 demultiplexes an optical signal transmitted by the second optical wireless communication device 1-2 into optical signals of a plurality of wavelengths.

In FIG. 3, an Array Waveguide Grating (AWG) is used as the first optical multiplexing and demultiplexing unit 103-1. The AWG is an optical waveguide using quartz, silicon, silicon nitride, or the like.

For example, the spectral characteristics of the AWG have a temperature dependence of approximately 0.08 nm/K and exhibit behavior in which a change in the temperature causes the port of a corresponding wavelength to shift to an adjacent port.

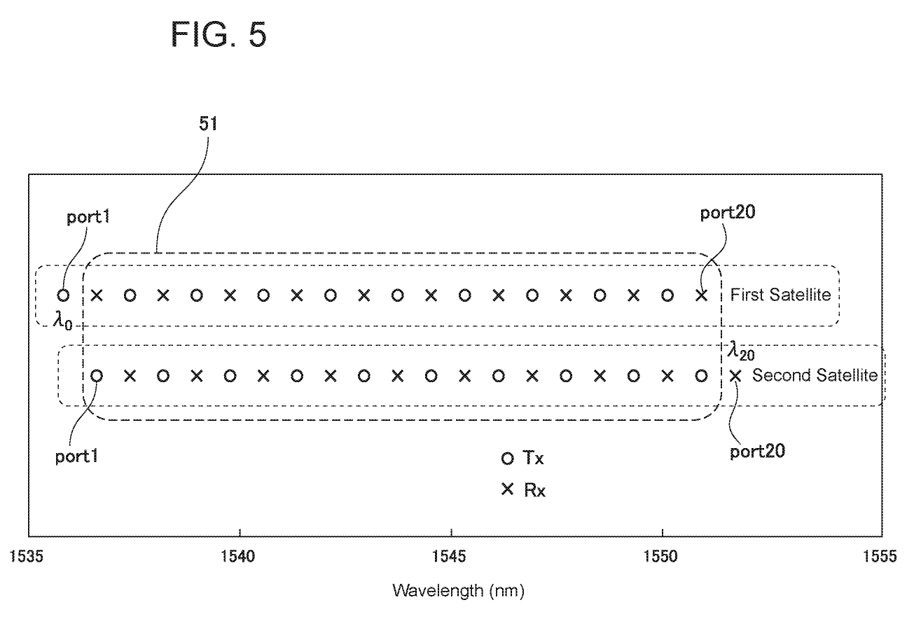

In a case where an AWG made of quartz is used as the first optical multiplexing and demultiplexing unit 103-1, as illustrated in FIGS. 3 and 5, a first optical transmitting unit 101-1 is connected to the first port (port1), and a first optical receiving unit 102-1 is connected to the second port (port2) in such a manner that the first optical transmitting units 101-1 and the first optical receiving units 102-1 are alternately connected to individual ports. Note that, in FIG. 5, reference sign 51 denotes wavelengths that can be used for communication in the optical wireless communication system.

Note that, in a case where the first optical multiplexing and demultiplexing unit 103-1 is an AWG, the first optical wireless communication device 1-1 may include a temperature control unit to perform temperature control for the first optical multiplexing and demultiplexing unit 103-1.

In addition, in a case where the first optical transmitting units 101-1 are DMLs or EMLs, the first optical wireless communication device 1-1 may include a temperature control unit to perform temperature control for the first optical transmitting units 101-1.

For example, as illustrated in FIG. 1, the second optical wireless communication device 1-2 is mounted on a second satellite 10-2 and communicates with the counterpart first optical wireless communication device 1-1.

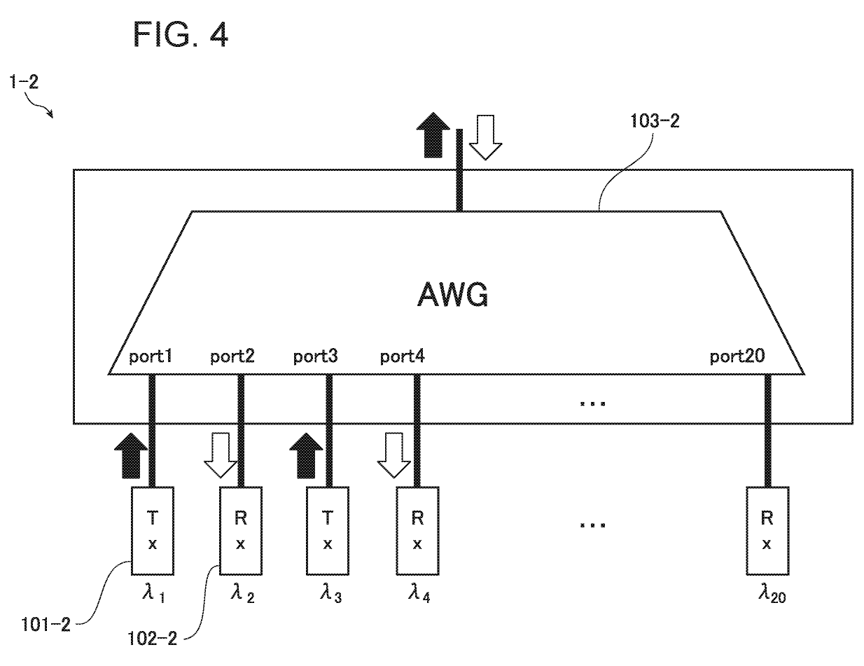

For example, as illustrated in FIG. 4, the second optical wireless communication device 1-2 includes a plurality of second optical transmitting units (Tx) 101-2, a plurality of second optical receiving units (Rx) 102-2, and a second optical multiplexing and demultiplexing unit (AWG) 103-2.

Each second optical transmitting unit 101-2 transmits an optical signal of a target wavelength to the second optical multiplexing and demultiplexing unit 103-2.

For example, semiconductor lasers are used as the second optical transmitting units 101-2. For example, DMLs or EMLs in which optical modulators are integrated are used as the semiconductor lasers.

For example, the oscillation wavelength of the DMLs and the oscillation wavelength of the EMLs have temperature characteristics of approximately 0.08 nm/K, and the wavelengths of optical signals to be output can be changed by changing the temperature.

Each second optical receiving unit 102-2 receives an optical signal of a target wavelength from among optical signals demultiplexed by the second optical multiplexing and demultiplexing unit 103-2.

For example, APDs are used as the second optical receiving units 102-2.

The APDs can receive light irrespective of temperature as long as the wavelength of the light falls within the wavelength band to which the APDs are sensitive.

In addition, the target wavelengths of the individual second optical transmitting units 101-2 and the individual second optical receiving units 102-2 are wavelengths allocated to the individual second optical transmitting units 101-2 and the individual second optical receiving units 102-2 alternately in order of length from among a plurality of the target wavelengths of the second optical wireless communication device 1-2.

In the example in FIG. 4, λ₁, λ₃, ⋅⋅⋅, and λ₁₉ are allocated to the individual second optical transmitting units 101-2, and λ₂, λ₄, ⋅⋅⋅, and λ₂₀ are allocate to the individual second optical receiving units 102-2.

The second optical multiplexing and demultiplexing unit 103-2 is an optical waveguide that has a plurality of ports and multiplexes and demultiplexes optical signals. The second optical multiplexing and demultiplexing unit 103-2 has a function of demultiplexing wavelength-multiplexed light into a plurality of ports and a function of multiplexing light of particular wavelengths input to a plurality of ports.

That is, the second optical multiplexing and demultiplexing unit 103-2 multiplexes optical signals transmitted by the second optical transmitting units 101-2 and transmits an optical signal obtained by the multiplexing to the first optical wireless communication device 1-1, and the second optical multiplexing and demultiplexing unit 103-2 demultiplexes an optical signal transmitted by the first optical wireless communication device 1-1 into optical signals of a plurality of wavelengths.

In FIG. 3, an AWG is used as the second optical multiplexing and demultiplexing unit 103-2. The AWG is an optical waveguide using quartz, silicon, silicon nitride, or the like.

For example, the spectral characteristics of the AWG have a temperature dependence of approximately 0.08 nm/K and exhibit behavior in which a change in the temperature causes the port of a corresponding wavelength to shift to an adjacent port.

In a case where an AWG made of quartz is used as the second optical multiplexing and demultiplexing unit 103-2, as illustrated in FIGS. 4 and 5, individual ports is connected alternately to a second optical transmitting units 101-2 and a second optical receiving units 102-2 in such a manner that the second optical transmitting unit 101-2 is connected to the first port (port1), and the second optical receiving unit 102-2 is connected to the second port (port2).

Note that, in a case where the second optical multiplexing and demultiplexing unit 103-2 is an AWG, the second optical wireless communication device 1-2 may include a temperature control unit to perform temperature control for the second optical multiplexing and demultiplexing unit 103-2.

In addition, in a case where the second optical transmitting units 101-2 are DMLs or EMLs, the second optical wireless communication device 1-2 may include a temperature control unit to perform temperature control for the second optical transmitting units 101-2.

In addition, for example, as illustrated in FIGS. 3-5, the target wavelengths of the first optical transmitting units 101-1 and the first optical receiving units 102-1 in the first optical wireless communication device 1-1 and the target wavelengths of the second optical transmitting units 101-2 and the second optical receiving units 102-2 in the second optical wireless communication device 1-2 are shifted from each other by one wavelength.

That is, in the example in FIGS. 3-5, while the target wavelengths of the individual first optical transmitting units 101-1 are λ₀, λ₂, ⋅⋅⋅, and λ₁₈, the target wavelengths of the individual second optical transmitting units 101-2 are λ₁, λ₃, ⋅⋅⋅, and λ₁₉ in such a manner that the targets wavelengths are shifted from each other by one wavelength. Similarly, in the example in FIGS. 3-5, while the target wavelengths of the individual first optical receiving units 102-1 are λ₁, λ₃, ⋅⋅⋅, and λ₁₉, the target wavelengths of the individual second optical receiving units 102-2 are λ₂, λ₄, ⋅⋅⋅, and λ₂₀ in such a manner that the target wavelengths are shifted from each other by one wavelength.

Note that in a case where the first optical multiplexing and demultiplexing unit 103-1 and the second optical multiplexing and demultiplexing unit 103-2 are AWGs, a port that cannot be used for communication occurs in each of the first optical multiplexing and demultiplexing unit 103-1 and the second optical multiplexing and demultiplexing unit 103-2 since the wavelengths are shifted as described above.

In the example in FIGS. 3 and 5, the first port (port1) in the ports that the first optical multiplexing and demultiplexing unit 103-1 has is a port that cannot be used for communication. That is, the first optical wireless communication device 1-1 operates using 19 wavelengths on the shortwave side. Similarly, in the example in FIGS. 4 and 5, the twentieth port (port20) in the ports that the second optical multiplexing and demultiplexing unit 103-2 has is a port that cannot be used for communication. That is, the second optical wireless communication device 1-2 operates using 19 wavelengths on the longwave side.

In addition, wavelength settings of the first optical wireless communication device 1-1 and the second optical wireless communication device 1-2 can be programmatically inverted.

That is, for example, in a case where the optical transmitting units 101 are DMLs or EMLs, the wavelengths of optical signals from the optical transmitting units 101 can be adjusted by adjusting the temperature setting values of the optical transmitting units 101. In addition, for example, in a case where the optical multiplexing and demultiplexing units 103 are AWGs, the wavelengths corresponding to the ports that the optical multiplexing and demultiplexing units 103 have can be adjusted by adjusting the temperature setting values of the optical multiplexing and demultiplexing units 103. Therefore, the wavelength settings of the first optical wireless communication device 1-1 and the second optical wireless communication device 1-2 can be programmatically inverted by performing these adjustments.

Note that FIGS. 2-4 illustrate only portions related to the present disclosure from among components that the optical wireless communication devices 1 have.

However, on the downstream sides of the input and output ports of the optical multiplexing and demultiplexing units 103, the actual devices include mechanisms such as circulators to separate transmitted and received optical signals, booster optical amplifiers for transmitted optical signals or low noise optical amplifiers for received optical signals, optical scanning mechanisms for performing tracking between the satellites 10, and the like.

Next, an example of operations performed by the optical wireless communication system according to the first embodiment is explained.

Communication is performed between the first optical wireless communication device 1-1 mounted on the first satellite 10-1 and the second optical wireless communication device 1-2 mounted on the second satellite 10-2 through the following operations. Note that it is assumed hereinbelow that the optical transmitting units 101 are DMLs or EMLs, and the optical multiplexing and demultiplexing units 103 are AWGs. In addition, whereas a case where the settings of the second optical wireless communication device 1-2 are modified on the basis of the settings of the first optical wireless communication device 1-1 is illustrated hereinbelow, the opposite may be adopted.

First, for example, the temperature setting value of the second optical multiplexing and demultiplexing unit 103-2 in the second optical wireless communication device 1-2 is increased to be 10°C higher than the temperature setting value of the first optical multiplexing and demultiplexing unit 103-1 in the first optical wireless communication device 1-1. Thereby, due to the temperature dependence of the second optical multiplexing and demultiplexing unit 103-2, the positional relationship of the ports with respect to wavelength shifts by approximately 0.8 nm (0.08 nm/K×10 K) to adjacent positions.

Furthermore, for example, the temperature setting value of the second optical transmitting units 101-2 in the second optical wireless communication device 1-2 is varied by 10°C relative to the temperature setting value of the first optical transmitting units 101-1 in the first optical wireless communication device 1-1. Thereby, due to the temperature characteristics of the second optical transmitting units 101-2, the wavelengths vary by 0.8nm.

By these adjustments, the wavelength allocation of the second optical transmitting units 101-2 and the second optical receiving units 102-2 in the second optical wireless communication device 1-2 can be inverted from the initial state. Thereby, the target wavelengths of the first optical transmitting units 101-1 and the first optical receiving units 102-1 in the first optical wireless communication device 1-1 and the target wavelengths of the second optical transmitting units 101-2 and the second optical receiving units 102-2 in the second optical wireless communication device 1-2 are shifted from each other by one wavelength.

It should be noted that the shortest wavelength in the first optical wireless communication device 1-1 and the longest wavelength in the second optical wireless communication device 1-2 cannot be used for communication.

Note that, since the wavelength dependence of the optical receiving units 102 is small, the variation of the wavelengths of optical signals accompanying a change in the temperature setting values of the optical multiplexing and demultiplexing units 103 does not affect the reception sensitivity. Accordingly, it is not necessary to modify the settings of the optical receiving units 102.

Then, communication is performed between the first optical wireless communication device 1-1 and the second optical wireless communication device 1-2.

Note that a case where the temperature dependence of the AWGs is 0.08 nm/K is illustrated in the description above. However, the temperature dependence of the AWGs is not limited to this and changes significantly depending on the design and material selection of the AWGs.

In this regard, the optical wireless communication devices 1 according to the first embodiment can cope with changes in the temperature dependence of the AWGs simply by adjusting the temperature setting values, and the basic operations illustrated above can be applied even when the temperature dependence of the AWGs changes.

In addition, not only DMLs or EMLs having oscillation wavelengths that change depending on temperature, but also wavelength-tunable lasers may be used as the optical transmitting units 101. In this case, a technique typically used for wavelength operation of a wavelength-tunable laser, for example heating with a heater, applying an electrical field, or the like, is used.

Next, advantageous effects of the optical wireless communication devices 1 according to the first embodiment are described.

First, since a large number of wavelengths can be allocated in the optical wireless communication devices 1 according to the first embodiment, the communication capacity can be enhanced.

In addition, the optical wireless communication devices 1 according to the first embodiment can be configured in two different settings while having an identical configuration. In the example described above, the optical wireless communication devices 1 with an identical configuration can be used on the first satellite 10-1 and the second satellite 10-2. Accordingly, not only is size reduction of the optical wireless communication devices 1 according to the first embodiment possible, but the number of product types can be reduced, allowing the devices to be manufactured at a lower cost compared with conventional techniques.

In addition, in the optical wireless communication devices 1 according to the first embodiment, modification of wavelengths is facilitated by allocating wavelengths alternately to the optical transmitting units 101 and the optical receiving units 102. Thereby, in the optical wireless communication devices 1 according to the first embodiment, in addition to allowing a simple configuration, the power consumption and heat generation amount can be reduced.

For example, when transmission signals of a plurality of wavelengths are allocated on the shortwave side of an ITU-T grid and reception signals of a plurality of wavelengths are allocated on the longwave side of the ITU-T grid in a wavelength division multiplexing scheme, switching among transmission and reception settings requires significant changes of wavelengths, requiring enormous power and a complex mechanism.

As described above, according to the first embodiment, an optical wireless communication system is the optical wireless communication system including a pair of the optical wireless communication devices 1, in which each of the optical wireless communication devices 1 includes: a plurality of the optical transmitting units 101 to transmit optical signals of target wavelengths; the optical multiplexing and demultiplexing unit 103 to multiplex the optical signals transmitted by the optical transmitting units 101 and transmit an optical signal obtained by the multiplexing to a counterpart optical wireless communication device 1, which is the other one of the pair of optical wireless communication devices 1, and to demultiplex an optical signal from the counterpart optical wireless communication device 1 into optical signals of a plurality of wavelengths; and a plurality of the optical receiving units 102 to receive optical signals of target wavelengths from among the optical signals demultiplexed by the optical multiplexing and demultiplexing unit 103, the target wavelengths of the optical transmitting units 101 and the optical receiving units 102 are wavelengths that are allocated alternately in order of length, and, between the pair of optical wireless communication devices 1, the target wavelengths of the optical transmitting units 101 and the optical receiving units 102 are shifted from each other by one wavelength.

In addition, according to the first embodiment, the optical multiplexing and demultiplexing units 103 are AWGs.

In addition, according to the first embodiment, the optical wireless communication system includes temperature control units to perform temperature control for the optical multiplexing and demultiplexing units 103.

Thereby, in the optical wireless communication system according to the first embodiment, a large number of wavelengths can be used, and wavelength switching is facilitated compared with conventional techniques.

In addition, according to the first embodiment, each optical wireless communication device 1 includes: a plurality of the optical transmitting units 101 to transmit optical signals of target wavelengths; the optical multiplexing and demultiplexing unit 103 to multiplex the optical signals transmitted by the optical transmitting units 101 and transmit an optical signal obtained by the multiplexing to a counterpart optical wireless communication device 1 and to demultiplex an optical signal from the counterpart optical wireless communication device 1 into optical signals of a plurality of wavelengths; and a plurality of the optical receiving units 102 to receive optical signals of target wavelengths from among the optical signals demultiplexed by the optical multiplexing and demultiplexing unit 103, and the target wavelengths of the optical transmitting units 101 and the optical receiving units 102 are wavelengths that are allocated alternately in order of length.

Thereby, in the optical wireless communication devices 1 according to the first embodiment, a large number of wavelengths can be used, and wavelength switching is facilitated compared with conventional techniques.

### Second Embodiment.

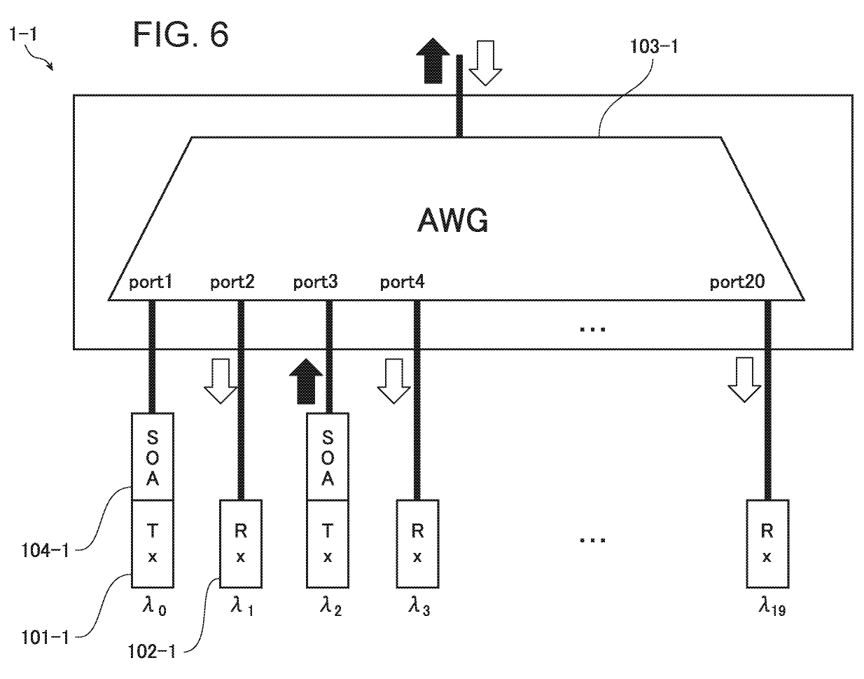

FIG. 6 is a drawing illustrating a configuration example of a first optical wireless communication device 1-1 according to a second embodiment.

The first optical wireless communication device 1-1 according to the second embodiment illustrated in FIG. 6 is obtained by adding first optical amplifying units (SOA) 104-1 to the first optical wireless communication device 1-1 according to the first embodiment illustrated in FIG. 3. Other configuration examples in the first optical wireless communication device 1-1 according to the second embodiment illustrated in FIG. 6 are similar to configuration examples in the first optical wireless communication device 1-1 according to the first embodiment illustrated in FIG. 3 and are given the same reference signs, and only differences are explained.

In addition, although the illustration is omitted, a second optical wireless communication device 1-2 according to the second embodiment is also configured similarly to the first optical wireless communication device 1-1 according to the second embodiment.

Note that first optical transmitting units 101-1 in the second embodiment are DMLs or EMLs.

For each first optical transmitting unit 101-1, a first optical amplifying unit 104-1 is provided between the first optical transmitting unit 101-1 and a first optical multiplexing and demultiplexing unit 103-1. The first optical amplifying unit 104-1 amplifies an optical signal transmitted by the corresponding first optical transmitting unit 101-1.

In FIG. 6, Semiconductor optical amplifiers (SOAs) are used as the first optical amplifying units 104-1.

Note that a first optical transmitting unit 101-1 and a first optical amplifying unit 104-1 may be configured by being monolithically integrated on a single semiconductor chip, or a first optical amplifying unit 104-1 in another package may be connected to a first optical transmitting unit 101-1 by free-space optics or using an optical fiber.

In addition, the first optical multiplexing and demultiplexing unit 103-1 in the second embodiment multiplexes optical signals obtained after amplification by the first optical amplifying units 104-1 and transmits an optical signal obtained by the multiplexing to the second optical wireless communication device 1-2.

Next, an example of operations performed by an optical wireless communication device 1 according to the second embodiment is explained.

In a case where coupling to an AWG or a single mode fiber is essential in the optical wireless communication device 1, DMLs or EMLs to operate in a single mode are necessary as optical transmitting units 101. Under such constraints, the optical transmitting units 101 do not provide particularly high outputs, and, for example, their outputs are equal to or lower than 100 mW, making it impossible to obtain several-hundred-milliwatt to several-watt outputs required for long-distance free-space optical communication.

In this regard, optical amplifying units 104 are mounted on the output sides of the optical transmitting units 101, which are DMLs or EMLs, in the optical wireless communication device 1 according to the second embodiment and amplify light input to each port of the optical multiplexing and demultiplexing unit 103. As a result, the optical wireless communication device 1 according to the second embodiment can obtain several-hundred-milliwatt to several-watt outputs required for long-distance free-space optical communication.

Next, advantageous effects of the optical wireless communication devices 1 according to the second embodiment are described.

In the optical wireless communication devices 1 according to the second embodiment, light input to each port of the optical multiplexing and demultiplexing units 103 can be increased in intensity. Accordingly, in the optical wireless communication devices 1 according to the second embodiment, optical amplifiers on the downstream sides of the optical multiplexing and demultiplexing units 103, for example fiber amplifiers such as EDFAs, become unnecessary, or low-gain optical amplifiers can be applied on the downstream sides of the optical multiplexing and demultiplexing units 103. As a result, simplification and size reduction of the optical wireless communication devices 1 according to the second embodiment are possible.

As described above, according to the second embodiment, the optical transmitting units 101 are DMLs or EMLs, each of the optical wireless communication devices 1 includes the optical amplifying units 104 to amplify the optical signals transmitted by the optical transmitting units 101, and each of the optical multiplexing and demultiplexing units 103 multiplexes optical signals obtained after the amplification by the optical amplifying units 104 and transmits an optical signal obtained by the multiplexing to the counterpart optical wireless communication device 1.

Thereby, in addition to the advantageous effects achieved in the first embodiment, the optical wireless communication system according to the second embodiment can increase the intensity of light output to the optical multiplexing and demultiplexing units 103.

### Third Embodiment.

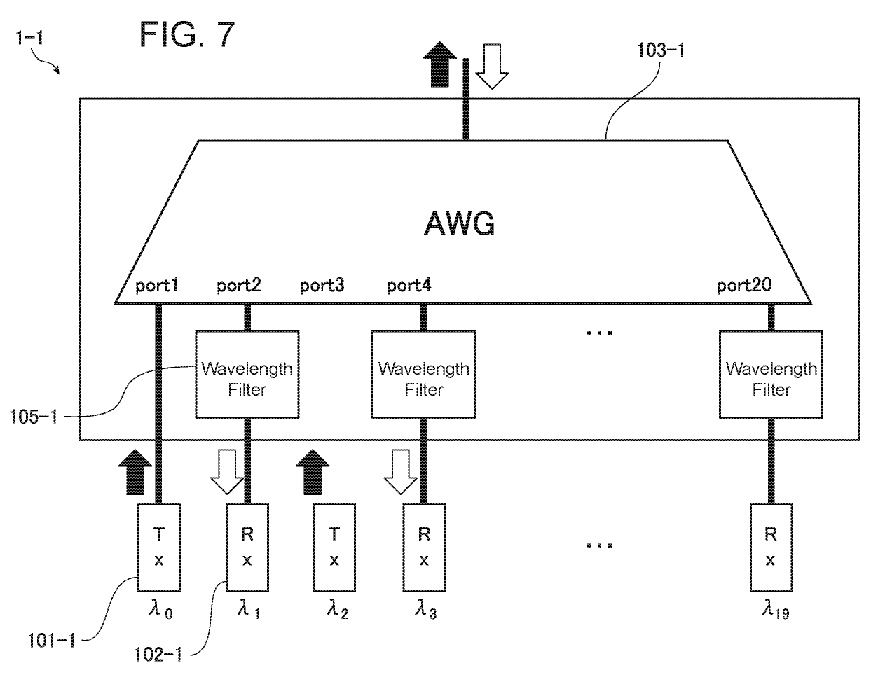

FIG. 7 is a drawing illustrating a configuration example of a first optical wireless communication device 1-1 according to a third embodiment.

The first optical wireless communication device 1-1 according to the third embodiment illustrated in FIG. 7 is obtained by adding first wavelength filters 105-1 to the first optical wireless communication device 1-1 according to the first embodiment illustrated in FIG. 3. Other configuration examples in the first optical wireless communication device 1-1 according to the third embodiment illustrated in FIG. 7 are similar to configuration examples in the first optical wireless communication device 1-1 according to the first embodiment illustrated in FIG. 3 and are given the same reference signs, and only differences are explained.

In addition, although the illustration is omitted, a second optical wireless communication device 1-2 according to the third embodiment is also configured similarly to the first optical wireless communication device 1-1 according to the third embodiment.

For each first optical receiving unit 102-1, a first wavelength filter 105-1 is provided between the first optical receiving unit 102-1 and a first optical multiplexing and demultiplexing unit 103-1. The first wavelength filter 105-1 transmits optical signals of two wavelengths which can be target wavelengths of the corresponding optical receiving unit 102 from among optical signals demultiplexed by the first optical multiplexing and demultiplexing unit 103-1 and blocks optical signals of other wavelengths.

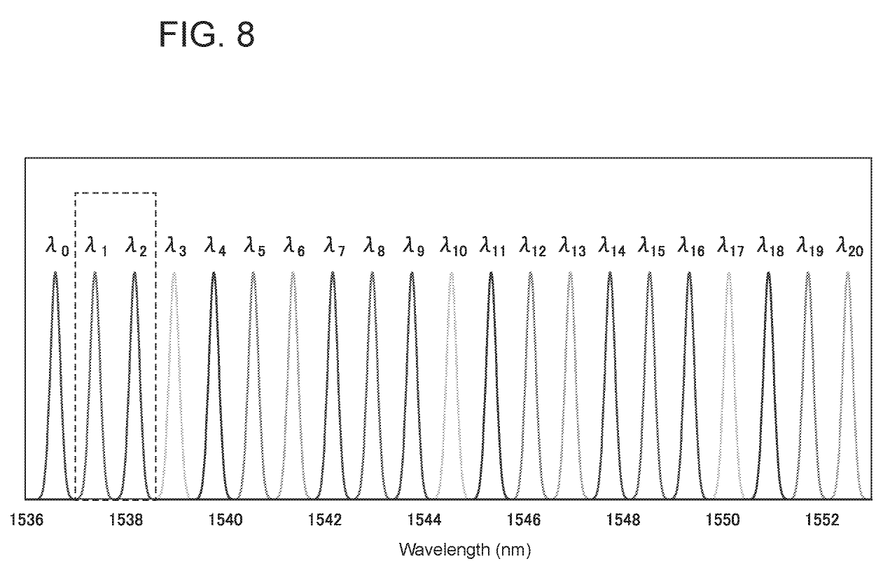

For example, in FIG. 7, different wavelengths are incident on a first optical receiving unit 102-1 connected to the second port (port2) depending on whether the optical wireless communication device 1 functions as the first optical wireless communication device 1-1 or functions as the second optical wireless communication device 1-2. Specifically, an optical signal of a wavelength of either λ₁ or λ₂ is incident thereon. Accordingly, in this case, the first wavelength filter 105-1 has a band that covers two wavelengths as represented by a dotted line in FIG. 8.

Note that each first wavelength filter 105-1 may be configured by being monolithically integrated on a chip on which the first optical multiplexing and demultiplexing unit 103-1 is fabricated or may be configured by being externally connected through an optical fiber or the like.

Next, an example of operations performed by an optical wireless communication device 1 according to the third embodiment is explained.

It is generally known that AWGs exhibit inter-port crosstalk of approximately 40 dB. In a case where signals of a large number of wavelengths exceeding ten wavelengths are received as in the first embodiment, the crosstalk of individual wavelengths accumulates, and there is a possibility that the total amount of crosstalk deteriorates by 10 dB or more.

In this regard, the optical wireless communication device 1 according to the third embodiment can cut off unrelated wavelengths by providing bandpass filters that can transmit particular wavelengths.

Next, advantageous effects of the optical wireless communication devices 1 according to the third embodiment are illustrated.

The optical wireless communication devices 1 according to the third embodiment can improve reception performance by filtering the crosstalk generated in AWGs. In addition, as illustrated in FIG. 8, by providing filters each of which covers two wavelengths, switchable operations as illustrated in the first embodiment can be enabled.

Note that, in the description above, a configuration obtained by adding wavelength filters 105 to an optical wireless communication device 1 according to the first embodiment is illustrated. However, this is not the sole example. A configuration obtained by adding wavelength filters 105 to an optical wireless communication device 1 according to the second embodiment may be adopted, and this can provide advantageous effects similar to those described above.

As described above, according to the third embodiment, each of the optical wireless communication devices 1 includes a wavelength filter 105 that is provided to each of the optical receiving units 102, the wavelength filter 105 transmitting optical signals of two wavelengths which can be target wavelengths of the corresponding optical receiving unit 102 from among the optical signals demultiplexed by the optical multiplexing and demultiplexing unit 103, and the corresponding optical receiving unit 102 receives the optical signals transmitted through the wavelength filter 105.

Thereby, in addition to the advantageous effects achieved in the first and second embodiments, the optical wireless communication devices 1 according to the third embodiment can block unnecessary wavelengths.

### Fourth Embodiment.

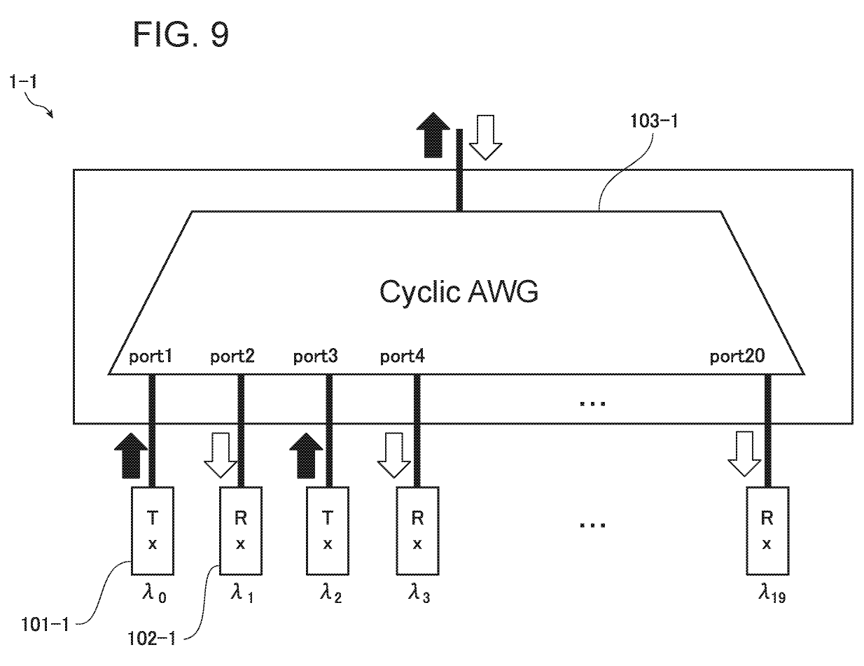

FIG. 9 is a drawing illustrating a configuration example of a first optical wireless communication device 1-1 according to a fourth embodiment. The first optical wireless communication device 1-1 according to the fourth embodiment illustrated in FIG. 9 is obtained by using a cyclic AWG as a first optical multiplexing and demultiplexing unit 103-1 in the first optical wireless communication device 1-1 according to the first embodiment illustrated in FIG. 3. Other configuration examples in the first optical wireless communication device 1-1 according to the fourth embodiment illustrated in FIG. 9 are similar to configuration examples in the first optical wireless communication device 1-1 according to the first embodiment illustrated in FIG. 3 and are given the same reference signs, and only differences are explained.

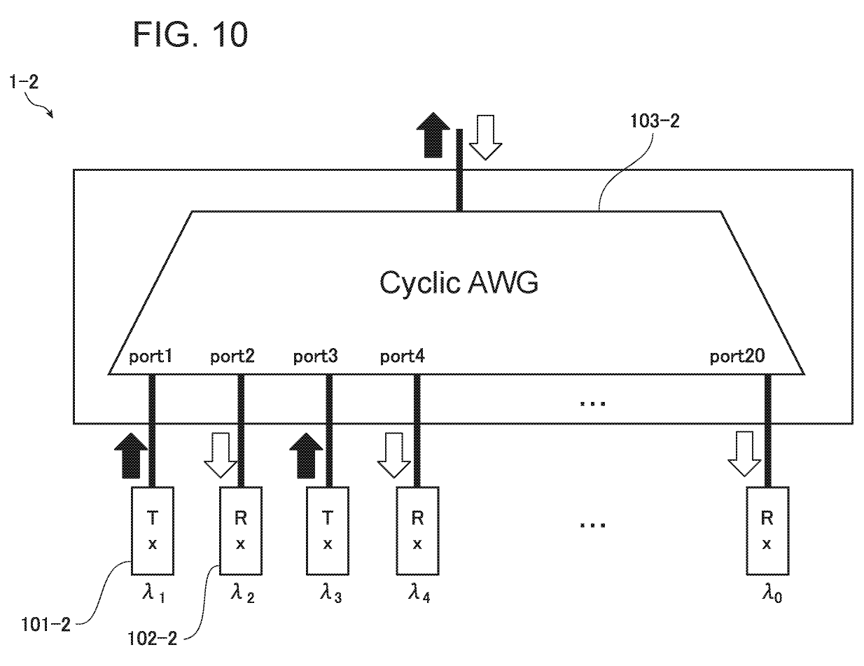

Similarly, FIG. 10 is a drawing illustrating a configuration example of a second optical wireless communication device 1-2 according to the fourth embodiment. The second optical wireless communication device 1-2 according to the fourth embodiment illustrated in FIG. 10 is obtained by using a cyclic AWG as a second optical multiplexing and demultiplexing unit 103-2 in the second optical wireless communication device 1-2 according to the first embodiment illustrated in FIG. 4. Other configuration examples in the second optical wireless communication device 1-2 according to the fourth embodiment illustrated in FIG. 10 are similar to configuration examples in the second optical wireless communication device 1-2 according to the first embodiment illustrated in FIG. 4 and are given the same reference signs, and only differences are explained.

The first optical multiplexing and demultiplexing unit 103-1 is a cyclic AWG. The cyclic AWG has cyclic wavelength characteristics.

The second optical multiplexing and demultiplexing unit 103-2 is a cyclic AWG. The cyclic AWG has cyclic wavelength characteristics.

That is, for example, the cyclic AWGs have a temperature dependence of approximately 0.08 nm/K and exhibit behavior in which a change in the temperature causes the port of a corresponding wavelength to shift to an adjacent port, and, in this regard, are similar to the AWGs illustrated in the first embodiment. On the other hand, as illustrated in FIGS. 9 and 10, the two wavelengths which can be target wavelengths of the last ports (port20) of the cyclic AWGs are λ₁₉ and λ₀. That is, the wavelengths are the last wavelength and the first wavelength of the target wavelengths of the optical wireless communication system according to the fourth embodiment.

In this case, λ₂₀ from among the target wavelengths of the optical wireless communication system illustrated in FIG. 2 is not necessary, and the target wavelengths of the optical wireless communication system according to the fourth embodiment are λ₀ to λ₁₉.

In a case where the first optical multiplexing and demultiplexing unit 103-1 and the second optical multiplexing and demultiplexing unit 103-2 are cyclic AWGs, there are no ports that cannot be used for communication in each of the first optical multiplexing and demultiplexing unit 103-1 and the second optical multiplexing and demultiplexing unit 103-2 since the wavelengths are shifted as described above.

Next, an operation example of an optical wireless communication device 1 according to the fourth embodiment is illustrated.

As illustrated in FIGS. 9 and 10, for example, in a case where λ₀ to λ₁₉ are used in the first optical wireless communication device 1-1, an optical signal of λ₀ is input to the twentieth port (port20) of the second optical wireless communication device 1-2 whose wavelengths have been shifted.

Next, advantageous effects of the optical wireless communication devices 1 according to the fourth embodiment are illustrated.

There is one port that cannot be used for communication in each optical wireless communication device 1 in the first embodiment. In this regard, it becomes possible to eliminate ports that cannot be used for communication in the optical wireless communication devices 1 according to the fourth embodiment by giving cyclic characteristics to the optical multiplexing and demultiplexing units 103, and communication capacity can be enhanced.

Note that, in the description above, a configuration in which a cyclic AWG is used as an optical multiplexing and demultiplexing unit 103 in an optical wireless communication device 1 according to the first embodiment is illustrated. However, this is not the sole example. A configuration in which a cyclic AWG is used as an optical multiplexing and demultiplexing unit 103 in an optical wireless communication device 1 according to the second embodiment or an optical wireless communication device 1 according to the third embodiment may be adopted, and this can provide advantageous effects similar to those described above.

As described above, according to the fourth embodiment, the optical multiplexing and demultiplexing units 103 are cyclic AWGs.

Thereby, in addition to the advantageous effects achieved in the first to third embodiments, the optical wireless communication system according to the fourth embodiment can enhance communication capacity.

Note that any combination of the embodiments, modification of any component in each of the embodiments, or omission of any component in each of the embodiments is possible.

### INDUSTRIAL APPLICABILITY

The optical wireless communication system according to the present disclosure makes it possible to use a large number of wavelengths and to facilitate wavelength switching compared with conventional techniques and is suited for being used for an optical wireless communication system including optical wireless communication devices to transmit and receive optical signals and the like.

### REFERENCE SIGNS LIST

1: optical wireless communication device; 1-1: first optical wireless communication device; 1-2: second optical wireless communication device; 10: satellite; 10-1: first satellite; 10-2: second satellite; 101: optical transmitting unit; 101-1: first optical transmitting unit; 101-2: second optical transmitting unit; 102: optical receiving unit; 102-1: first optical receiving unit; 102-2: second optical receiving unit; 103: optical multiplexing and demultiplexing unit; 103-1: first optical multiplexing and demultiplexing unit; 103-2: second optical multiplexing and demultiplexing unit; 104: optical amplifying unit; 104-1: first optical amplifying unit; 105: wavelength filter; 105-1: first wavelength filter

1. An optical wireless communication system comprising a pair of optical wireless communication devices, wherein
each of the optical wireless communication devices includes:
a plurality of optical transmitters to transmit optical signals of target wavelengths;
an optical multiplexer/demultiplexer
to multiplex the optical signals transmitted by the optical transmitters and transmit the multiplexed optical signal to a counterpart optical wireless communication device, which is the other one of the pair of optical wireless communication devices, and to demultiplex an optical signal from the counterpart optical wireless communication device into optical signals of a plurality of wavelengths;
a plurality of optical receivers to receive the optical signals of target wavelengths from among the optical signals demultiplexed by the optical multiplexer/demultiplexer; and
a wavelength filter that is provided to each of the optical receivers, the wavelength filter transmitting optical signals of two wavelengths which are target wavelengths of the corresponding optical receiver from among the demultiplexed optical signals by the optical multiplexer/demultiplexer, wherein
the target wavelengths of the optical transmitters and the optical receivers are wavelengths that are allocated alternately in order of length,
between the pair of optical wireless communication devices, the target wavelengths of the optical transmitters and the optical receivers are shifted from each other by one wavelength,
the optical multiplexer/demultiplexers are AWGs,
the number of ports is one greater than a total number of the target wavelengths of the optical transmitters and the optical receivers, and
the corresponding optical receiver receives the optical signals transmitted through the wavelength filter.

2. An optical wireless communication system comprising a pair of optical wireless communication devices, wherein
each of the optical wireless communication devices includes:
a plurality of optical transmitters to transmit optical signals of target wavelengths;
an optical multiplexer/demultiplexer to multiplex the optical signals transmitted by the optical transmitters and transmit the multiplexed optical signal to a counterpart optical wireless communication device, which is the other one of the pair of optical wireless communication devices, and to demultiplex an optical signal from the counterpart optical wireless communication device into optical signals of a plurality of wavelengths;
a plurality of optical receivers to receive the optical signals of target wavelengths from among the optical signals demultiplexed by the optical multiplexer/demultiplexer; and
a wavelength filter that is provided to each of the optical receivers, the wavelength filter transmitting optical signals of two wavelengths which are target wavelengths of the corresponding optical receiver from among the demultiplexed optical signals by the optical multiplexer/demultiplexer, wherein
the target wavelengths of the optical transmitters and the optical receivers are wavelengths that are allocated alternately in order of length,
between the pair of optical wireless communication devices, the target wavelengths of the optical transmitters and the optical receivers are shifted from each other by one wavelength,
the optical multiplexer/demultiplexers are cyclic AWGs,
the number of ports is equal to a total number of the target wavelengths of the optical transmitters and the optical receivers, and
the corresponding optical receiver receives the optical signals transmitted through the wavelength filter.

3. The optical wireless communication system according to claim 1, wherein each of the optical wireless communication devices includes a temperature controller to perform temperature control for the optical multiplexer/demultiplexer .

4. The optical wireless communication system according to claim 2, wherein each of the optical wireless communication devices includes a temperature controller to perform temperature control for the optical multiplexer/demultiplexer.

5. The optical wireless communication system according to claim 1, wherein
the optical transmitters are DMLs or EMLs,
each of the optical wireless communication devices includes an optical amplifier to amplify the optical signals transmitted by the optical transmitters, and
each of the optical multiplexer/demultiplexers multiplexes the amplified optical signals by the optical amplifier and transmits the multiplexed optical signal to the counterpart optical wireless communication device.

6. An optical wireless communication device comprising:
a plurality of optical transmitters to transmit optical signals of target wavelengths;
an optical multiplexer/demultiplexer to multiplex the optical signals transmitted by the optical transmitters and transmit the multiplexed optical signal to a counterpart optical wireless communication device, which is the other one of the pair of optical wireless communication devices, and to demultiplex an optical signal from the counterpart optical wireless communication device into optical signals of a plurality of wavelengths;
a plurality of optical receivers to receive the optical signals of target wavelengths from among the optical signals demultiplexed by the optical multiplexer/demultiplexer; and
a wavelength filter that is provided to each of the optical receivers, the wavelength filter transmitting optical signals of two wavelengths which are target wavelengths of the corresponding optical receiver from among the demultiplexed optical signals by the optical multiplexer/demultiplexer, wherein
the target wavelengths of the optical transmitters and the optical receivers are wavelengths that are allocated alternately in order of length,
between the pair of optical wireless communication devices, the target wavelengths of the optical transmitters and the optical receivers are shifted from each other by one wavelength,
the optical multiplexer/demultiplexers are AWGs,
the number of ports is one greater than a total number of the target wavelengths of the optical transmitters and the optical receivers, and
the corresponding optical receiver receives the optical signals transmitted through the wavelength filter.

7. An optical wireless communication device comprising:
a plurality of optical transmitters to transmit optical signals of target wavelengths;
an optical multiplexer/demultiplexer to multiplex the optical signals transmitted by the optical transmitters and transmit the multiplexed optical signal to a counterpart optical wireless communication device, which is the other one of the pair of optical wireless communication devices, and to demultiplex an optical signal from the counterpart optical wireless communication device into optical signals of a plurality of wavelengths;
a plurality of optical receivers to receive the optical signals of target wavelengths from among the optical signals demultiplexed by the optical multiplexer/demultiplexer,
a wavelength filter that is provided to each of the optical receivers, the wavelength filter transmitting optical signals of two wavelengths which are target wavelengths of the corresponding optical receiver from among the demultiplexed optical signals by the optical multiplexer/demultiplexer, wherein
the target wavelengths of the optical transmitters and the optical receivers are wavelengths that are allocated alternately in order of length,
between the pair of optical wireless communication devices, the target wavelengths of the optical transmitters and the optical receivers are shifted from each other by one wavelength,
the optical multiplexer/demultiplexers are cyclic AWGs,
the number of ports is equal to a total number of the target wavelengths of the optical transmitters and the optical receivers, and
the corresponding optical receiver receives the optical signals transmitted through the wavelength filter.
